(19) United States
(12) Patent Application Publication
(10) Pub. No.: US 2014/0279591 A1
(43) Pub. Date: Sep. 18, 2014

(54) NETWORK-BASED REAL ESTATE MARKETPLACE DATABASE AND LOCATION-BASED MATCHING

(71) Applicant: Eric T. Trailer, Palo Alto, CA (US)

(72) Inventor: Eric T. Trailer, Palo Alto, CA (US)

(21) Appl. No.: 14/201,079

(22) Filed: Mar. 7, 2014

Related U.S. Application Data
(60) Provisional application No. 61/780,487, filed on Mar. 13, 2013.

(51) Int. Cl. G06Q 50/16; G06Q 10/10

(52) U.S. Cl. CPC G06Q 50/16; G06Q 10/10
USPC 705/313

(57) ABSTRACT

A system and method for location-based matching of buyers and sellers of real estate is disclosed. In one embodiment, a method includes receiving an identifier of a geographic location from a mobile device, determining a geographic area that includes the geographic location, identifying at least one seller entry that includes an identifier of a real estate property located within the geographic area in a database of real estate records for buyers and sellers, identifying at least one buyer entry in the database that matches the at least one seller entry, and sending the at least one seller entry and at least one buyer entry to the mobile device. In one embodiment, the method includes querying a public real estate database to obtain public information about properties in the geographic area that includes the geographic location received from the mobile device.

### FIELD OF THE INVENTION

The present invention relates to the field of real estate and more particularly to an internet based real estate marketplace.

### BACKGROUND

As is commonly known, the sale of a personal residence from a seller to a buyer typically is facilitated by real estate agents representing the buyers and sellers. Most real estate agents belong to a local chapter of the National Association of Realtors (NAR). Belonging to the NAR entitles an agent to be called a Realtor®. Realtors pay dues and are members in good standing with the NAR. Not every licensed agent is a Realtor. In order to assist in the purchasing and selling of real estate, an agent must pass a real estate licensing exam and maintain proper broker affiliation as required by state law. Not everyone that has a real estate license is necessarily a full time actively practicing professional.

A typical buyer in a real estate transaction will use a licensed real estate agent to help find suitable property that meets their personal requirements. The buyer will usually have a preference for a type of residence, such as (but not limited to) a single family home, a condominium, or a townhouse. The buyer will further have preferences for a bedroom count, bathroom count, and square footage of the dwelling. The buyer will also have a limit of what is affordable as well as a preference for a location and even a lot size. Real estate agents may also help buyers find a buildable lot for sale, an investment property, or a second home.

Most people attempting to sell a property use a real estate agent to help identify and attract buyers. In order to find buyers, real estate agents work with sellers to stage a dwelling and hold it open for showings. Real estate agents also negotiate the real estate sales contract and supervise property inspections and disclosures.

The critical element to a successful real estate sale is matching an interested buyer with an available property for sale. Compensation for the real estate agent typically comes from the seller (from the proceeds of the sale) to the real estate agent representing the seller who splits the received fee with the real estate agent representing the buyer.

Real estate agents are licensed under brokers that supervise the transactions. Real estate agents also work under real estate companies. A real estate company holds a “broker” level license and can range in size. Each office offers a varying level of support for the agents.

Dating back over a hundred years, licensed real estate agents joined a Multiple Listing Service® (MLS) in order to find properties for their buyers and advertise their sellers' properties to others. The MLS is only available to member Realtors in the National Association of Realtors. For years, local MLS services published books listing real estate for sale which evolved into searchable computer systems accessible over the internet. Local MLS service organizations would restrict access to the MLS information to their member Realtors in good standing. The real estate information was specifically restricted from being viewed by the Realtors' clients without an agent present. In 2007, following anti-trust litigation, internet based searchable MLS data was made widely available to the general public without any need for involving a licensed real estate agent.

There is still a requirement that before a property is listed through an MLS service, there has to be a binding contract between a seller and a real estate agent (referred to as the listing agent) which stipulates a price that the seller is willing to accept and an agreement to pay the listing agent. There are also often requirements that inspection reports be completed and available to buyers. Some examples of the types of inspections that may be required include a house inspection, a termite report, a roof report, and a mold report.

Sellers do not always want to list their properties for sale on the MLS because, for example, they are not ready to commit to a sale price. Therefore, real estate agents will often maintain a list of potential sellers that they are in contact with regarding selling a property, but, are not part of MLS. Real estate agents also maintain a list of potential clients who are interested in finding a property to buy. The MLS does not maintain any database of buyers. So, someone selling a house cannot look to MLS to find a listing of potential buyers. Nor can someone find a list of all possible sellers because of the strict requirements of the MLS and the requirement that there be a contract in place.

While real estate agents often maintain lists of potential buyers whom they are in contact with regarding the purchase of a property, there is no seamless organized way for an agent to inform other agents who might have a client with a property for sale, know about the needs of her client looking to buy a property since the MLS only organizes lists of agents and their sellers and does not maintain a database of buyers. Nor, as mentioned, can an agent find a list of potential sellers, through MLS, because of the strict requirement of the MLS and the requirement that there be a contract in place. To the extent other computerized programs have attempted to provide this information, they fall far short of the needs of the real estate agents.

Real estate agents within a geographic region are often working together to complete a real estate transaction when one is a seller's agent and the other is a buyer's agent. However, agents in a given geographic region (or even within a real estate office) are also in competition with each other for attracting clients. So, while it is valuable for agents to share information about all of their potential buyers and sellers, agents do not want to disclose the names of their clients. Real estate agents are especially secretive of their buying clients because often there is no contract between the agent and a buying client. The same is true for potential sellers, who might be considering selling their property only if the agent can find a buyer, but, is not contractually committed to selling that property.

Real estate agents conduct searches for properties listed on the MLS using a computer interface terminal attached to the internet. An agent, having a client in mind, will select a geographic area, a price range, a type of residence, such as condominium or single family residence, and a minimum square footage. A searcher can also limit the search by designating a minimum number of bedrooms or bathrooms, and a minimum lot size. The MLS database retrieves a report listing all the available properties that meet the search criteria. The search results can be stored and retrieved at a later time.

The volume of properties available in a given area can change daily as some properties come on the market and others go off the market either for not being sold within a contractual period or because a sale has been reached. Such properties can stay in the database but are listed as having a sale pending.

There are a number of systems available to real estate agents to provide search capabilities for non-MLS listed property as well as potential buyers. For example, within a real estate office, systems are available for broadcasting within that office, what new properties might be coming on the market soon as well as what types of properties are being sought by buyers that real estate agents in that office are working with. This may include emailing other agents or keeping a list in the office of off-market properties, or sharing at an office meeting about the needs of a client or a property that might be offered for sale in the near future.

However, there is a need for a straightforward easily accessible way of relaying information between real estate agents of what properties may be available for purchase, although not yet listed for sale, and what types and locations of properties are being sought by buyers. Successful real estate agents can be working with dozens of buyers and sellers at a time. There is a great need for real estate agents to be able to quickly access information on a given buying or selling client in order to more efficiently meet the needs of the agent's own buying and selling clients.

There are a number of computerized tools that are designed with real estate agents in mind to help them to organize all of the data they require to help their clients. An example is Agent Achieve from CoreLogic. This product provides an interface to the public MLS internet website integrated with contact management utilities and reporting tools.

Real estate agents need to be able to organize all of the data relating to each client so that the real estate agent can pull up the relevant information at any time to be able to update a client on progress. Also, if a new property comes to the real estate agent's attention, she needs to be able to correlate that property with the client that would be interested whether as a buyer or a seller. In a highly competitive market, the more information available to a real estate agent, the better able that agent is to be able to accommodate a client and make a sale.

However, there also can be a problem of too much data. The real estate agent can become overwhelmed by too many leads on clients that are not going anywhere and not be able to focus on the more active clients. Therefore, the real estate agent needs to organize which clients are more active, which leads might be too old to be relevant and within all that keep track of what new properties or new buyers that come to their attention, might fit with one of their clients.

A real estate agent might also know that there are a number of clients who in the near future will need to buy a certain property type for certain tax purposes, for example. There are also many owners that might be waiting for property values to go up to get a greater price for their home before offering it for sale. Certain buyers might be looking for property values to come down before they feel they are able to afford to purchase a home. A real estate agent typically wants to keep track of all of these potential future clients.

Real estate agents also need to provide marketing materials on themselves to show how many sales they have had and for example how many of their properties sold for over the asking price. Also, in selling a given house, a real estate agent would want to show the trend in the market as an added incentive to purchase a property. Therefore, real estate agents need to be able to prepare comparative market analysis. Typically, real estate agents rely on the MLS database to provide data on past sales and current listings to provide a comparison to a given property value and desirability.

Real estate agents do not currently have a way of including in their trend analysis, off market data, such as how many buyers are looking in an area as well as how many houses are for sale, just not under contract with a real estate agent or listed in the MLS database. This added data provides a great marketing tool for the real estate agent in securing a client to work with her. This is particularly true now that the MLS database is searchable by the public. More and more people feel that they can find their own property to buy and forego a realtor to save on the commission. However, if a realtor can show how many properties are sold without ever even showing up on the MLS, the real estate agent can show the benefit of using a real estate agent to find the best properties that are available in an area.

In general there is a need for real estate agents to have access to as much relevant data as exits. There is also a need to sort through if some data is not relevant so that they are not overwhelmed with too much noise. There is also a need to easily and efficiently correlate matching buyers and sellers. There is also a need to be able to keep posted on new buyers and sellers as soon as they are known to a realtor. There is also a need to have a concise location to store all notes on a client and to be able to communicate with a client or other realtors in an efficient manner.

### SUMMARY

A process and system for providing an automated web based real estate marketplace is disclosed. In one embodiment of the invention, a method is provided for managing a real estate marketplace using a database accessible through the internet by a plurality of registered agents. The system provides at least one screen useable by at least one registered agent for entering information on at least one buyer entry into the database representing a buyer client. Each buyer entry includes an agent contact data field for an owning agent, a buyer contact data field for the buyer, a property description field containing a description of a property the buyer wants to buy, a price field containing a range amount for buying the property, and at least one location field for the property is located.

At least one screen is provided by the system useable by a registered agent to enter at least one seller entry into the database representing a seller client. Each seller entry includes an agent contact data field for an owning agent, a seller contact data field, a property description field containing a description of a property the seller is offering for sale, a price field containing a range amount of how much money the seller would likely accept for the property, and a location field containing the location of the property.

Access to each buyer contact data field in the database is limited by the system to the owning agent who entered the entry for that buyer. Matching seller entries and buyer entries in the database are automatically identified based on common property description fields, common price fields, and common location fields.

A dashboard display screen is provided that is accessible by each registered agent. The dashboard screen displays a catalog of the buyer entries for the registered agent, a catalog of the seller entries for the registered agent, any matches between the buyer entries for the registered agent and any seller entries in the database, and any matches between the seller entries for the registered agent and any buyer entries in the database.

A further embodiment comprises designating seller entries and buyer entries as expired either after a period of time or by the registered agent. Expired entries are archived and not displayed on the dashboard to the registered agent with the inventory of buyers and sellers. Further, the seller entries and buyer entries can be designated as active or passive at any time and all registered agents in the database can see the designation for each entry. Preferably the properties for sale in the database are not found on the Multiple Listing Service.

In a further embodiment of the invention, comments can be associated with each buyer and seller client entry which cannot be seen by registered agents in the database other than the owning agent.

In a further embodiment of the invention, a catalog of most recent entries for the database is also displayed as part of the dashboard. Recent entries in the designated geographic preference are displayed in the catalog for a registered agent.

In a further embodiment of the invention a communication portal is provided by which registered agents are able to communicate with each other within the marketplace. In a further preferred embodiment, entries are searchable based on preference options including geographic location, property type and price range, wherein the available options are provided based on prior selections.

In one embodiment, a geo-targeting module is configured to receive geo-location data from a mobile agent device and to utilize that geo-location data to identify information in the database that is relevant to that geographic location. The geo-targeting module may be further configured to query repositories of public real estate records to obtain public information about properties corresponding to geo-location data received from a mobile agent device.

### BRIEF DESCRIPTION OF THE DRAWINGS

FIG. 1 shows a block diagram of one embodiment of a networked computer system according to the invention.

FIG. 2 shows one embodiment of a dashboard web page according to the invention.

FIG. 3 shows an exemplary embodiment of a catalog of buyers area of the dashboard of FIG. 2.

FIG. 4 shows an exemplary embodiment of a catalog of sellers area of the dashboard of FIG. 2.

FIG. 5 shows an exemplary embodiment of a catalog of buyer matches area of the dashboard of FIG. 2.

FIG. 6 shows an exemplary embodiment of a catalog of seller matches area of the dashboard of FIG. 2.

FIG. 7 shows an exemplary embodiment of a message center area of the dashboard of FIG. 2.

FIG. 8 shows an exemplary embodiment of a live feed area of the dashboard of the dashboard of FIG. 2.

FIG. 9A shows an exemplary embodiment of a catalog display of all of an agent's clients that are potential buyers.

FIG. 9B shows an exemplary embodiment of a catalog display of all of an agent's clients that are potential sellers.

FIG. 10A shows an exemplary embodiment of a display that allows an agent to add a new client that is a potential buyer.

FIG. 10B shows an exemplary embodiment of a display that allows an agent to add a new client that is a potential seller.

FIG. 11 shows an exemplary embodiment of a display that allows an agent to edit client data.

FIG. 12 shows an exemplary embodiment of a display of an agent's potential matches for the agent's clients in the database.

FIG. 13 shows an exemplary embodiment of a display highlighting a particular match for a client of an agent found in the database.

FIG. 14 shows an exemplary embodiment of a display screen that enables searching for properties and buyers contained in the database based on selected criteria.

FIG. 15 shows an exemplary embodiment of a display screen that shows details of a search result.

FIG. 16A shows an exemplary embodiment of a display screen that enables an agent to monitor whether buyers are designated as on the clock.

FIG. 16B shows an exemplary embodiment of a display screen that enables an agent to monitor whether sellers are designated as on the clock.

FIG. 17 shows an exemplary embodiment of a display screen used to register agents to access the database.

FIG. 18 shows an exemplary embodiment of the display used for system administration.

FIG. 19 shows an exemplary embodiment of a display used to define parameters by the system administrator.

FIG. 20 is a flowchart of method steps for using geo-location data to identify seller entries and buyer entries, according to one embodiment of the invention.

FIG. 21 is a flowchart of method steps for using geo-location data to query public real estate records, according to one embodiment of the invention.

### DETAILED DESCRIPTION

Embodiments of the present invention comprise systems and processes for providing a real estate marketplace database accessible over the internet.

The marketplace database is populated with data provided by real estate agents with information on their clients that are potential buyers and sellers of real estate. Real estate agents register to belong to the marketplace database and then input data on their buying and selling clients' wants and needs. The information on the identities of the buyers and sellers remains confidential to the real estate agents that input that data. However, the real estate agents that are part of the marketplace share information with each other regarding details of their clients' real estate preferences.

Referring to FIG. 1, an exemplary system is shown including a web server 10 connected to the internet 12. The web server 10 comprises a web site 14 that assists in carrying out processes according to the present invention as described herein. The web-based real estate marketplace comprises a plurality of web-based real estate records stored in a database 16 wherein each real estate record pertains to a registered real estate agent's buyer or seller client. A processor, residing in a server 10, provides access to the database records through an information management system. The processor and server 10 also provide a matching algorithm and communication functions. Server 10 generates web pages through web site 14 which are distributed through the internet to agent devices 18. The database records pertain to information about potential buyers and sellers that are known to agents registered in the system. In one embodiment, server 10 includes a geo-targeting module 15 configured to receive geo-location data from a mobile agent device 18 and to utilize that geo-location data to identify information in the database 16 that is relevant to that geographic location.

Within the web-based real estate marketplace, registered professional real estate agents can interact with other registered professional real estate agents and compile an inventory system chronicling their buying and selling clients. A professional real estate agent is one who is practicing full time and established in a community. Real estate agents who are actually themselves consumers (buyers or sellers) are kept out of this marketplace, as will be more fully described below.

According to a preferred embodiment of the invention the marketplace created by the registered real estate agents is focused on a specific geographic location which can be narrowed or enlarged by the agent. The agents enter records describing their clients' needs which become part of the marketplace database.

The database used by this system, is preferably, not stored at a local server site, although this would be a possible implementation. The data can be stored in a host system or a managed dedicated server. In the preferred embodiment, the data is stored using cloud computing sites, such as Go Daddy, Hostway, or others. The data is stored at many sites accessible through the internet.

Each agent device 18 is coupled to the internet network and can readily communicate with other computers and storage devices connected through wired networks, wireless networks, and/or combinations of wired and wireless networks, which is well known in the art. Each agent device 18 includes the ability to access the database 16 in order to retrieve information or to update the database 16 only if each device is used by a registered agent who is logged in. Agent device 18 may be any type of computing device capable of accessing web pages on the Internet, including but not limited to desktop computers, notebook computers, tablet computers, and smartphones.

In order to have a successful real estate marketplace, it is important to have a large inventory of potential buyers and sellers represented by real estate agents registered and actively using this system. However, as part of the usability and effectiveness of this system, it is also important to limit the noise from any irrelevant data. Furthermore, it is important that the data be reliable. The data that is being supplied by the registered agents and comprises the database is on buyers and on sellers that are not part of the MLS database. The non-MLS selling client data entered into this system pertains to properties that the agents are able to use their professional judgment and experience to determine that sellers will want to sell. Likewise, the buyers that are part of this system are interested and motivated buyers.

In the preferred embodiment, not everyone with a real estate license is able to register and be part of the marketplace. An agent needs to be approved for admission and registration. New members of the on-line marketplace community are typically referred by other agents already registered in the system. As mentioned previously, in many states, it is possible for anybody to be able to attain a real estate license by passing a real estate licensing examination. This is done in order to more fully participate in one's own real estate transaction (actually be a consumer). But, these consumer “agents” do not work with clients and are not part of the local real estate community. The marketplace provided by this invention is designed to be able to limit membership in the marketplace database to real estate agents in the community who are in good standing within the community, as will be more fully described later.

FIG. 2 shows a home page view 20 of the marketplace system, referred to as a dashboard view. The dashboard view is the screen that a registered professional agent sees when logging onto the marketplace database.

At the Dashboard 20, the agent (for example Mary) can quickly see a buyers catalog 22 of all of her clients in the marketplace who are interested in buying a property and a sellers catalog 23 of all of her clients in the marketplace who are interested in selling a property. She can also see a match catalog of all of the matches in the marketplace for her buyers 24 and a match catalog of all of the matches for her sellers 25. The matches in the catalogs are between the agent's clients and other clients that have been entered into the marketplace database.

Referring to FIG. 2, the agent can also see, from the dashboard screen 20, all of her buyer entries that are about to expire 26 and all of her seller entries that are about to expire 27. Client entries that are about to expire are referred to as “on the clock.” When a client is set to “expire” the data associated with that client becomes archived. Clients are designated as set to expire when they have been in the system for longer than a predetermined time. In the preferred embodiment, the expiration time is thirty days from when the entry was made or from when the agent last “renewed” the entry, as will be more fully explained below. Clients are shown in these “on the clock” sections 26, 27 when they have been entered for more than twenty-five days. The clients that are on the clock remain viewable in these sections 26, 27 for five days. After that time, if the agent does not renew this client, the information associated with this client becomes designated as “archived.” lithe owning agent decides that the client is still viable, she can renew the client, as will be explained further. The owning agent can also choose to designate a client as archived at any time.

Clients are categorized as “active,” “passive,” or “archived.” The designation of “active or “passive” is community information that all agents in the marketplace database can see. Clients that are designated archived are no longer viewable by any other agent in the database. Archived clients cannot be part of a match.

Dashboard 20 also has a message center section 28 where the agent is able to message another agent registered in the database, look up contact data for another agent in the database, send a message to all agents in her office who are also registered in the marketplace database, and send a message to any one of her clients that she has input into the database. The agent can also send a message to all agents registered in the database that have clients in the database that meet selected criteria, as will be discussed further.

As shown in FIG. 2, the agent also sees a live feed listing 30 of the most recent entries into the database. As registered agents enter their new clients into the database, the new entry data instantly appears in the live feed areas 30 (separated as buyers and sellers) of the dashboard 20 of all of the registered agents in the marketplace database.

A more detailed view of the dashboard of FIG. 2, is provided by FIGS. 3-8. With reference to FIG. 3, the “buyers” catalog section 22 of the dashboard is shown in greater detail. The buyers catalog section 22 shows a subset of the most recently entered buyers for the agent. The agent can scroll through the catalog of buyers on the dashboard. The agent can also navigate to a separate screen listing all of her buyers by selecting the “View All” link 34 in the upper right hand corner of the buyer display 22. The screen view of the full catalog of all the agent's buyer or seller clients is shown in FIG. 9a and described in greater detail below. There are other ways to navigate to the screen with the full catalog of the agent's buyers, such as selecting the “Buyers” option at the top band 35 of the dashboard 20 under the “Clients” option.

The dashboard buyers section 22 would not show those clients that are no longer “on the clock” and were archived because they had been in the system more than thirty days without the agent renewing or re-clocking the client as still being viable in the market. On the full buyer display screen (FIG. 9a), the agent would be able to see her buying clients that had been archived and are no longer on the clock.

As shown in FIG. 3, the agent can also navigate directly to a display screen which enables adding a buyer by selecting the “Add Buyer” link 38 on the top right hand corner of the buyer display section 22. The agent can also navigate to the display screen that enables adding a buyer by making a selection of the “Clients” option on the top band 35 and then selecting to “Add a Buyer” when this option appears below the words “Clients.”

As shown in FIG. 3, the agent sees relevant data about each of her buyers, such as, the name of the buyer 39, the location where the buyer is looking to purchase a property 40, the number of bedrooms and bathrooms the buyer would like 41, 42, and the price range 43. It is readily understood that the relevant information can easily vary. For example, this display can also include the type of dwelling. The purpose of the display content is to let the real estate agent see the most relevant information about her clients as efficiently as possible.

Referring to FIG. 4, the “sellers” catalog section 23 is laid out similar to the “buyers” section 22. A catalog listing of the agent's current clients looking to sell their properties 44 is displayed. For each seller, the agent sees the name of the seller 45, the location of the property for sale 46, the number of bedrooms and bathrooms in the property 47, 48, and the price range 49 that the seller would be willing to accept to sell the property. The agent is able to select to “View All” 50 and “Add New” 51 sellers from the sellers catalog section 23 of the dashboard display screen 20.

Both the buyer and seller sections 22, 23 of the dashboard provide an option 54 that the agent can select to edit a given client entry. By selecting this option the agent would go to the edit client screen (described below).

The next display area the agent views as she scrolls down the dashboard screen 20 shows her the matches the system has found for her buyers and her sellers. FIGS. 5 and 6 show, in more detail, the buyer and seller matching sections 24, 25, respectively, of the dashboard view 20.

As shown in FIG. 5, the buyer matches are shown by identifying the name of the buyer 55a and the general information about the type and location of a property the buyer is interested in purchasing. As shown, this information includes the city where the desired property is located 56a and the number of bedrooms and baths 57a and the price range 58a of an acceptable property. In order to see a more complete entry, the agent selects the client and the agent navigates to the match detail screen (FIG. 13). As more fully described below, the match detail screen provides the name of the other registered agent in the marketplace database that has a seller offering a property for sale that meets the criteria of this client of this agent.

In one embodiment, the dashboard view 20 includes a number of alert bubbles 60 on the header of the matches section, the on the clock section and the message center section. The purpose of the alert bubbles is to let the agent know how many new entries are in that section. For example, for the matches portion of the dashboard screen, the alert bubble 60 tells the agent how many new matches have been identified for her clients by the matching algorithm since the last time she logged in. The on the clock section alert bubble tells the agent how many clients fall in the five day window and need attention in order not to be automatically archived after thirty days. The message center alert bubble tells the agent how many new messages the agent has received since she had last logged into the marketplace system.

From the agent matching screen the agent can select the description of the matching property to automatically go to the full match screen and send a message to that agent to discuss the match. The full match screen shows all of the details about the match, as will be described below.

The seller matches section 25 of the dashboard, as shown in FIG. 6, is similar to the buyer matches section with the same features and functionality. The names of all of the agent's sellers 55b that currently have a match in the marketplace database are listed. Next to the name of the matched seller is a description of the matched property including the location 56b, the number of bedrooms and bathrooms 57b and the price range 58b. There is also an alert bubble 60 that tells the agent how many new matches for her client she has since she had last logged in to this site.

The next section of the FIG. 2 embodiment of the dashboard 20 shows the message center 28. This is shown in greater detail in FIG. 7. The message center also includes an alert bubble 60 that tells the agent the number of new messages that she has received since her last visit.

Referring to FIG. 7, the message center portion of the dashboard provides an easy mechanism for the agent to broadcast information about a client or property to everyone in her office or to one or more other agents in the marketplace database or to a client. As shown in FIG. 7, the left hand side of the message center section 28 provides options for the agent to select that pertain to her clients' needs. The agent uses these options to choose who should receive the message. For example, if the agent wants to send out a message for a client looking to sell a three bedroom house in a certain neighborhood, she can select to send a message to agents that have clients looking to buy a three bedroom house in that neighborhood. The first category 62 the agent selects is whether the message is about a buyer or seller. The agent can also select a city 63, a property type 64, and a value range 65. These criteria are to be used to determine to whom the message would go. Only agents that have entered clients into the database that match these criteria would receive this message.

The agent can also use these criteria to identify what the message is about if she chooses to send the message to all other registered agents in her office 66. Additionally, the agent can look up a particular client of hers or another registered agent 67 in the database to send a message. The agent types in the name of the client or other agent and the database retrieves the information necessary to send a message through the system.

Below the criteria selection portion of the message center is an area 68 in which the agent can enter the message. Below the area to enter the message 68 is an area 70 which tells the agent that has selected criteria for who the message will go to, which agents and/or clients will receive the message.

As mentioned, the option selections can be used to identify other registered agents who meet the selected criteria and will receive the message, and also, can be used to describe the client or property or client that the message regards, when the message goes to a particular agent or the entire office. The first option is for the category 62. The options available are buyer or seller. The next option is the city 63 that the client either has a property to sell or is looking to buy. The other two options are the property type 64 and value 65. The list of available property types include single family, a one to four story condominium, a five story or taller condominium, a multi-family 2-4 units, land, and manufactured. The value is expressed in ranges such as $500,000 to $1,000,000, $1,000,000 to 1,500,000, and so on.

In one embodiment, the options that the agent can select to describe a client are dynamic. The location 62 lists a number of cities which are in the selected counties that the agent indicated she was interested in when she registered. When a city is selected, neighborhood options are displayed (not shown). The selection of the neighborhood option affects the property type options and the property value options that are displayed. This accommodates certain cities that have limited types of properties. For example, a city such as San Francisco is more likely to have a greater than five story condominium. The property type and location selection made by the agent then affects the ranges that are displayed. A less affluent area would have ranges in the lower values and more affluent areas would have ranges in the higher values.

The message center portion 28 of the dashboard 20 also includes a section 72, on the right hand side that provides a list of message alerts for the agent. The agent can place the mouse cursor over the message to go to another screen with a fuller display of the received message. The agent can then directly respond back to the agent that had sent the message with a reply message also from this screen (not shown).

Referring to FIG. 8, another feature for the agents in the dashboard view 20 of the marketplace database is a live feed area 30 where agents can see the most recent client additions to the database within the agent's chosen area. The live feed area is divided between a catalog of buyers and catalog of sellers. This area is updated as new clients are added by other agents within the same geographic area. If the agent wants to find out more about a listed buyer or seller, the agent can select that line and go to another screen with all the details of the entry and a communication portal to contact the agent that entered that entry.

Referring to FIG. 9A, a Buying Clients screen shows the agent a catalog of all clients that are interested in purchasing a property. This screen can be reached either directly from the header section 35 of the dashboard 20 or by selecting “view all” 34 on the buyer portion 22 of the client section. The agent can place the cursor over the word CLIENTS on the header 35. The two options of BUYERS or SELLERS appear and the agent selects the one she wants to view. If buyers is selected, the agent then goes to the screen shown in FIG. 9A.

In that way, right from the dashboard screen 20, the agent, Mary, can access a list of all of her clients. These include Active Clients, Passive Clients, and Archived Clients (off the clock). Active clients are the clients that are actively in the market (buyers or sellers). Passive clients are the clients that are in the market (buyers or sellers) but are less motivated. These statuses are visible to the other agents so that they can know how serious she feels her client is about buying or selling real estate at the present time. Active or Passive clients are visible to other agents for thirty days and then become archived unless Mary takes action to keep them from being archived and no longer considered “on the clock.” This system ensures that any agent knows that any client information from any other agent in the database that she is viewing is not stale since it is thirty days old or less. Archived clients are clients that will not appear in any new results to any other agent.

Referring to FIG. 9A, a catalog list 80 of buyers is shown. Each buyer entry 79 includes the buyer's name 81, the property type 82, and a status 83 (as described previously). Additionally, for each buyer, a value is displayed representing what had previously been supplied by the agent for the square foot of the home 84, square foot of the lot 85, the number of bedrooms 86, the number of bathrooms 87, of the type of property the buyer is seeking. Also displayed is the city 88 and neighborhood 89 in which the buyer would like to purchase a property as entered by the agent. Finally, a value 90 of how much the buyer can afford or is likely willing to spend is also provided for display for each buyer on this screen. There is also an area where the agent can select from a set of actions 91 to take with regards to this entry. The agent can select to edit 92 this entry, which will take the agent to another screen for editing this entry. The agent can also indicate that this client is no longer an active buyer 93 or suspend 94 the buyer, or delete 95 the buyer entry entirely. In one embodiment, if a buyer is marked as inactive or suspended, that buyer entry is considered a deactivated or “missed” transaction. When deleting a buyer, the agent is offered a screen to input whether the transaction has been successfully closed, and if so, to enter a revenue amount for that transaction. This information is then stored in database 16.

The agent also has an option 96 of sorting the entries 79 she is viewing using any of the displayed criteria such as: most recently added, by status, by property type, by desired square footage dwelling (lowest to highest or highest to lowest), by square footage lot (lowest to highest or highest to lowest), number of bedrooms (lowest to highest and highest to lowest), by square footage baths (lowest to highest and highest to lowest), by city (from A to Z or from Z to A), by value (from lowest to highest or highest to lowest).

As shown in FIG. 9B, a similar screen to FIG. 9A, is also available for the agent to see all of her clients 97 who have property they want to sell. These include clients that are active, inactive, and archived. The information displayed in each entry 98 includes the status, the client name, the property the client has to sell, a description of that property including property type, square footage of house and lot, location of the property (city and neighborhood), and the value that the seller would like to receive for the property. There are also actions that the agent can select for each entry, including editing the entry, changing the status of the entry, and deleting the entry. The display order of the entries can also be sorted 99 for the selling clients in a similar way as described for the buying clients

From the Display All Buyer and Display All Seller screens (FIGS. 9A and 9B), the agent can select an option 100 to move to a screen to add another seller or buyer (FIGS. 10A and 10B) and also select an option 101 to move directly between the screen showing her sellers to a screen showing her buyers and vice versa.

Referring to FIG. 10A, the agent, Mary, can add buyers and define their specific property criteria using the Add Buyer screen. FIG. 10B shows a similar screen for adding a selling client.

As shown in FIGS. 10A and 10B, there is a “private” area 102 where the agent enters information that only the agent will see and a “community” area 103 where the agent enters data that the entire community of registered agents can see. The private section has a place to enter the client's first and last name 104 as well as contact information such as their phone number and e-mail address 106. This information is not accessible by the other agents registered in the database. There is also a private note space 108 for the agent to write private notes about the client that no other registered agent has access to. The private area 102 also includes a metric information area (not shown) where the agent can enter an estimate of the time until closing (typically a number of months), and estimates of the total commission, the agent's split of the total commission, and the buyer broker's split of the total commission (each typically a percentage).

The “community” area 103 is for entering information about the client that the community of registered agents will see which pertains to a description of the property the seller wants to sell or the buyer is looking to buy. The community information also includes the agent's identification of the client's status as “active” or “inactive” 109. The property criteria that can be defined include the price range 110 and desired location 112, from county 113 down to a neighborhood 114. The counties that are provided as options for the agent are the ones that she selected when she registered to join the marketplace database. The state where the counties are found does not have to be provided as an option because it does not change from when the agent registered for the database. Similarly, if the agent is only interested in one county or one city, those options do not have to be entered. Further criteria include, but are not limited to, the property type 116, number of bedrooms 117, number of bathrooms 118, the lot size 119, and home size 120. The agent can also enter information pertaining to the buyer's financial status. The financial status refers to whether the buyer can pay in cash 122 and if not whether the buyer is pre-approved for a loan 123. These criteria can be used by a seller agent to judge how desirable this buyer would be to negotiate with.

The Add Seller screen (FIG. 10B) includes most of the same options as the Add Buyer screen. The Add Seller screen does not include a space to describe the client's financial contingencies. However, in a further embodiment, there could be additional information about the property that can be entered such as whether the seller is in foreclosure. The private area of the Add Seller screen also includes a metric information area (not shown) where the agent can enter an estimate of the time until closing (typically a number of months), and estimates of the total commission, the agent's split of the total commission, and the buyer broker's split of the total commission (each typically a percentage). The community area of the Add Seller screen may also enable the agent to indicate that the seller's property will be listed on the MLS in the future and to input an expected date for that listing. On that date, the server 10 will automatically mark that seller entry as inactive. Such an inactive seller entry will no longer appear in any agent's matches with a buyer entry. The public area of the Add Seller screen may also enable the agent to upload one or more image files of the property being offered for sale. Such images will appear on any match pages that include a match with that property.

When entering the data for the property type, the options are provided for the agent's selection. These options include a single family home, a one to four story condominium, a greater than five story condominium, a townhouse, a multi-unit two to four family building, buildable land, or a manufactured structure. The location of the property the seller is offering for sale or the location the buyer would like to purchase a property is categorized by the counties selected by the agent. When a county is selected, a list of cities in that county is provided for selection. Once a city is selected, an agent is given an option to next select from a list of neighborhoods. The choice of the city and neighborhood affects the options provided for the types of property.

When adding a buying client, there is also an area 124 for the agent to enter selections for the buyer's alternative preference cities and neighborhoods. For a new selling client, the Add Seller screen does not need to include this section since there the client has a property that is located in a particular city and neighborhood.

As shown in FIGS. 10A and 10B there is also a space to add comments 125 regarding this client that are available for the community of registered agents to view. For example, if a seller would like to hold their home open the following week that information can be made available to the community. Or, if there is something about the property that the community might want to know about, such as a newly remodeled kitchen, the agent has a way of letting the other agents know. Also, an agent might want to inform the community that a particular buyer is looking for a home that needs work.

As shown in FIGS. 10A and 10B, the community comment area for buyers and sellers is divided into four areas. The first area is for comments related to the style of the home structure and the condition of that structure. The second area is for comments regarding information on the interior and its condition. The third area is for the additional location information and information regarding the schools for that location. The fourth area is for other miscellaneous information that does not fall into one of the previous categories.

Once an agent has entered all of her buying and selling clients into the database, she can edit the records for these clients at any time. The screen 130 that provides her easy access to modify a buyer entry is shown in FIG. 11. There are many ways for the agent to reach this screen. Directly from the dashboard 20, she can scroll down her list of buyers or sellers and then when this client is located she can move the cursor over it and select.

As shown in FIG. 11, the “Edit client” page 130 is similar to the “Add Buyer” and “Add Seller” pages. However, when the agent visits this page all the data currently available on this client is already entered into the option spaces. The page shows whether this client is a buyer or a seller 131 as well as a description of the property being offered for sale or sought. The description of the property includes the square footage 132 of the dwelling and lot, the number of bedrooms and bathrooms 133, and the location 134. The description of the location 134 includes the county, the city and the neighborhood. The agent can also modify the amount 135 that the buying client would be able to pay for the property or a selling client would be willing to accept in an offer for sale. For a buying client, the agent can also update if the client's financial status has changed 136 from being able to pay cash or becoming pre-approved for a loan. Also for a buying client, the agent can change the secondary choices for the city 137 and neighborhood 138 where the client is seeking a property. The agent can also change her public and private comments about this client, or add new comments.

The agent makes a change to one of the sales criteria by moving the cursor over the relevant box and entering a different selection. The agent can change, delete or add a comment by placing the cursor at the relevant location and beginning to type a new comment or use the delete keys.

An important feature of the marketplace database system is that it includes a matching program that resides on the server 10 that automatically finds matches between registered agents' buying and selling clients. When an agent enters a new client data, the matching program seeks out potential matches with other clients previously entered into the database. When a match is found the relevant information on the match is transmitted to both agents. The accomplishment of this task uses algorithms known to those skilled in the art. The match information appears as previously described, on the dashboard screen 20 of both agents. From the dashboard 20, the agent can scroll through a list of all of the matches for her clients, separated by buyers and sellers, in the matches sections 24, 25, previously described. She can also navigate to a full “matches” page 140 for her buyers, sellers, or both. The agent also navigates to the “matches” page 140 by selecting View All on the “matches” portion 24, 25 of the dashboard 20 or by selecting MATCHES on the dashboard header 35.

As shown in FIG. 12, the matches screen has separate sections 141, 142 for the agent's buyers and sellers. Both areas list the name of the client 143, the other agent 144 that has a client that matches the needs of this agent's client, the property type 145 (as previously described), the square footage of the home 146, the square footage of the lot 147, the number of bedrooms 148, the number of bathrooms 149, the city 150 where the property is located, the county 151, and the value 152 of the property. The agent also has two actions 153 that she can take regarding each match listed. The first action the agent can take is to delete the match if the agent does not consider it to be a good match after further investigation with the counterpart agent. The agent also has the option of flagging the match to the system administrator who can investigate with the counterpart agent whether misleading or erroneous data had been entered into the system.

The agent can select any of the listed matches either in the “matches” screen 140 or the “matches” sections 24, 25 of the dashboard 20, to go to a full match comparison screen 160 as shown in FIG. 13. The match comparison screen 160 provides information on the counterpart agent 162, an area to contact 164 the counterpart agent, a side by side comparison 166 of the two client needs, and an area to rate 168 the match or delete the match if it does not seem to sufficiently meet the needs of the agent's client after initial comparison or after investigation with the counterpart agent.

The agent information area 162 includes the name of the counterpart agent, the brokerage with which the counterpart agent is affiliated, the city where the brokerage is located, and the email and phone number of the counterpart agent for this match. The agent can also contact the counterpart agent directly through the marketplace system which includes a communications portal at the server 10.

The agent interfaces with the communication portal in the message area 164. The agent types a message to the counterpart agent in the message area 170 and then selects SEND. There is also a log of the communication history that the agent can scroll through to see the history of communication between these two agents regarding these client and their matching needs.

The side by side comparison 166 shows line by line each of the client's stated needs so the agent can see and determine the appropriateness of the match. The data includes the property type, the square footage of the home, the square footage of the lot, the number of bedrooms and bathrooms, the value of the property (how much the buyer is willing or able to spend versus how much the seller wants to receive), the location of the desired property versus the location of the property for sale including the county, city and neighborhood.

The side by side comparison 166 extends to the community note categories which are also aligned for ease of comparison. The four categories of style of structure and condition, information on the interior and condition, additional location information including school information, and additional property information are aligned on the client and match sides of this screen.

Based on this side by side comparison and/or after discussion with the counterpart agent, this agent can rate the match on a scale of one to three or delete the match if it's deemed too far off for this client. The matching program has some flexibility in showing matches. If a property for sale is slightly less than what a buying client is willing to buy, this will show up as a match. Also, if someone provides as a requirement a house with two bedrooms and two bathrooms, but, there is a house with even more bedrooms or bathrooms in the buyer's price range in the same desired neighborhood, this would also show up as a match. Sometimes a property might seem like a match, but, it is described as needing repairs and an agent might know that her client needs a property in perfect condition, so that although the matching program will identify a match, further investigation by the agents can reveal that the displayed match is in fact not an ideal match for these clients. The matching program provides a great benefit to the agents to highlight promising matching properties that narrow what an agent needs to investigate further to help her client.

In addition to finding matches through the matching program, registered agents can also conduct their own searches to see what properties are available for their buying clients and to find buyers for their selling clients. FIG. 14 shows one embodiment of a Search screen 180. The agent navigates to the Search screen 180 either from the header 35 on the dashboard 20 or the Live Feed area 30 of the dashboard 20.

Referring to FIG. 14, the agent can select from search criteria 182 provided which include client type (buyer or seller), property type (previously described options), price range, square footage of the home, square footage of the lot, number of bedrooms and bathrooms and location. The location options include the list of the cities 184 in the agent's preferred counties and then the neighborhoods 186 within those cities. Each selection also has the option to see all available properties in the database or all buyers in the database. The agent also can select as many cities 184 and neighborhoods 186 as desired. The results will not show expired data.

The results area 194 lists all data in the system that meets the search criteria. There is also an option 192 to select how the results will be displayed. The options relate to the various criteria or showing most recent entries. The criteria include the status of the client (active or inactive), the agent, the property type, the square footage home and lot, the number of bedrooms and bathrooms, the city and county, and the value. Each can be sorted from lowest to highest and from highest to lowest, from A to Z and from Z to A.

The agent can select an item in the catalog of search results 194 by selecting the corresponding action option 198. The agent then goes to a Client Detail screen, shown in FIG. 15. The client detail screen shows all the public community information on the client. For this screen, the term client does not refer to a client of the agent currently viewing the screen, but rather refers to any client of any agent registered in the database.

The Search Result Detail Page 200 shows information on the agent 210 who entered this client into the database including the agent name, brokerage affiliation, address of the brokerage, phone number of the agent, and email of the agent. There is also a description of the property 212, which can be either the property that a buyer is seeking or a property that a seller is looking to sell. The property information 212 includes the property type, the square footage of the home, the square footage of the lot, the number of bedrooms, the number of bathrooms, the value of the home, the city, and the neighborhood. For buyers, the client detail page would also list if the buyer is a cash buyer or is pre-approved with a mortgage lender for a mortgage loan.

The client detail page also includes any public comments 216 in the four categories provided by the system, style of structure, interior and condition, location and school, and additional information. The client detail page also has a communication portal 214 to directly communicate with the agent listed with this client.

Referring to FIGS. 16A and 16B, the agents are able to manage the status of their clients by going to the On the Clock screen for buyers and sellers. Clients that had been entered into the system thirty days prior show up in the “On the Clock” area 26, 27 of the dashboard 20 and can be reviewed and edited from the screens shown in FIGS. 16a and 16b. The agent has five days from when the client shows up in this area to mark them as continuing to be part of the database and not archived. The agent can also move clients that are currently considered part of the database to be archived at any time even prior to the thirty days if the agent deems that these clients are not interested anymore in buying or selling a property. The agent can also change the status of a client from active to inactive based on a perception of how motivated the client is to buy or sell. An archived client is not deleted from the system. If at a later time, the agent feels the client is once again interested in buying or selling that client can be moved from an archived status. Archived clients do not show up in searches or as a match.

Referring to FIG. 17, the initial screen wherein an agent registers to join the marketplace system is shown. An agent wishing to join the marketplace enters the requested data in order to become a registered member. As shown, each agent enters a first and last name, the state, county, and city where a main office is located, a real estate license number, a license expiration date, an email address, a cell phone number, an office phone number, and a brokerage name if applicable. Each agent must also enter a professional reference of someone that can verify that this agent is a full time working real estate agent in good standing within the community. The agent also can enter a link to a professional website. The agent will next select a desired user name and password that is acceptable by the system administrator.

The agent at this time also chooses which counties within a chosen state are of interest. The data received by the agent will be limited to these selected counties so that the agent will not be inundated with irrelevant data.

Referring to FIGS. 18 and 19, the administrative screens are shown. The system administrator can provide flexibility to change, add, or cancel an agent and to modify the relevant options available to the system using the administrative screen. The administrator can add cities, neighborhoods, brokerages, property types, and users. The new options may be added based on requests from the agents. The administrator can also add the parameters that are available for a city or neighborhood. A given area will have a defined set of property types associated with that area. For example, an urban area will have larger condominiums and special co-ops. These are defined as an “urban parameter.” A defined area will also vary in its property values. Some defined areas (such as a more rural area) may vary in prices from under a million to several million. Other defined areas will have property prices that start at over a million and extend to ten million. The administrative section provides flexibility to update the system based on changes over time to an area that becomes more urban or to accommodate an area's rising or dropping property values.

Referring to FIG. 18 the administrator's screen is shown. The administrator can add and suspend agents from the USERS selection. The administrator can also change passwords for agents that have forgotten their password. If there is a problem with an agent's use of the system, they can be suspended.

The administrator also has flexibility as new areas are added or changed due to natural growth, to update parameters for those area. Additionally, as information associated with agents change, such as new brokerages coming into being or others going away, this too can be updated by the administrator from this screen.

When a new agent enters information as shown in FIG. 17, the agent will enter information on the brokerage with which they are affiliated. The application screen will provide a list of brokerages already in the system to select. If one of these is selected all the information already known about that brokerage can be associated with that agent's record information. If the brokerage is not known, the applying agent can request that the brokerage be added to the system. The agent supplies the name of the brokerage firm to the administrator. The administrator then adds this brokerage to a list of possible options for the next agent that applies to join the marketplace database.

Likewise, an agent can request to add a new city or neighborhood not currently listed as an option in the database. This occurs when the range of agents expands, but also when new neighborhoods are defined over time. Within a city or neighborhood or county (for rural areas) the administrator can define parameters for are attached to these defined locations. These parameters correspond to what cities are provided as an option within each county, and what neighborhoods are provided as an option within each city. The parameter are also used to define the property types within a defined location. For example, as shown in FIG. 19, the city of Palo Alto, Calif. can have defined for it the parameter of Group City 1. The property types that then appear as options for selection when an agent is adding a buyer or seller, would be, for example, Single Family, Townhome/Cond, Multifamily 2-4 unit, or Lots/Land.

The administrator can also define a property value associated with a location. In the preferred embodiment eight parameters have been defined of ranges that a location type can use. These values show up as range values when an agent enters a new client depending on the values of the properties in that area. An example of a range of property values for a location like Palo Alto, Calif. is: Less than $500K, $500K-$1M, $1M-$1.5M, $1.5M-$2M, $2M-$2.5M, $2.5M-$3M, $3M-$3.5M, $3.5-$4M, $4M-$5M, $5M-$6M, $6M-$7M, $7M-$10M, as Greater than $10M. For some other areas, this would not be helpful categories because all properties would fall in the first category of less than five hundred thousand, or only in the first two categories. For the categories to be helpful for identifying matches and to find appropriate buyers and sellers, the ranges need to correspond to useful categories of sales in a geographic area.

Returning to FIG. 1, in one embodiment, an agent device 18 is a mobile device such as a tablet or smartphone that is configured to enable the geographic location of the mobile device to be determined. Typically, such a mobile agent device 18 will include a Global Positioning System (GPS) circuit that determines the geographic location of the device 18 and can provide the geo-location data to other systems and processes on the mobile agent device 18. Mobile agent device 18 includes an application configured to receive geo-location data from a GPS circuit and configured to access server 10 over Internet 12. In one embodiment, server 10 includes a geo-targeting module 15 configured to receive geo-location data from a mobile agent device 18 and to utilize that geo-location data to identify information in the database 16 that is relevant to that geographic location. Geo-targeting module 15 may be further configured to query repositories of public real estate records to obtain public information about properties corresponding to geo-location data received from a mobile agent device 18.

FIG. 20 is a flowchart of method steps for using geo-location data to identify seller entries and buyer entries in database 16, according to one embodiment of the invention. In step 2010, geo-targeting module 15 of server 10 receives geo-location information from a mobile agent device 18. The geo-location information may be in any appropriate format, including but not limited to a latitude and longitude position or a street address. In step 2012, geo-targeting module 15 identifies seller entries in database 16 that correspond to the geo-location data received from the mobile agent device 18. In one embodiment, geo-targeting module 15 first identifies a city and neighborhood whose geographic location includes the location represented by the received geo-location data. Geo-targeting module 15 then identifies seller entries in database 16 that match that city and neighborhood. In other embodiments, geo-targeting module 15 may first identify a particular address, a county, or any combination of an address, a neighborhood, a city, or a county. The particular type of geographic area identified by geo-targeting module 15, for example a county, a city, a neighborhood, or address, may be predetermined by geo-targeting module 15 or selected as part of a request from the mobile agent device 18.

In step 2014, geo-targeting module 15 identifies buyer entries in database 16 that match the seller entries identified in step 2012, using the matching techniques described above. In step 2016, geo-targeting module 15 filters the seller entries and matching buyer entries by the requesting agent, who is the registered agent that logged into server 10 using the mobile agent device 18. Geo-targeting module 15 removes from the set of matching buyer entries and seller entries any match for which neither the buyer entry nor the seller entry was entered by the requesting agent. Geo-targeting module 15 thus produces a list of matches of buyer entries and seller entries for a particular agent that is limited to the current geographic location of the agent mobile device 18. In another embodiment, filtering step 2016 is not performed and geo-targeting module 15 produces a list of matches of buyer and seller entries limited to the current geographic location of the agent mobile device 18 but is not limited to those matches belonging to the particular requesting agent. In step 2018, geo-targeting module 15 send the list of matching buyer entries and seller entries to mobile agent device 18. The mobile agent device 18 will then display the list of matching buyer entries and seller entries on a display device.

FIG. 21 is a flowchart of method steps for using geo-location data to query public real estate records, according to one embodiment of the invention. In step 2110, geo-targeting module 15 of server 10 receives geo-location information from a mobile agent device 18. The geo-location information may be in any appropriate format, including but not limited to a latitude and longitude position or a street address. In step 2112, geo-targeting module 15 determines one or more properties that correspond to the received geo-location data. For example, if the geo-location data is a street address, geo-targeting module 15 uses that street address to identify the property at that location. If the geo-location data is a latitude and longitude position, geo-targeting module 15 identifies one or more properties within a predetermined radius of that geographic position.

In step 2114, geo-targeting module 15 queries one or more repositories of public real estate records for the identified properties to obtain public information about those properties. Such public information may include but is not limited to property type, number of bedrooms, number of bathrooms, owner, and lienholder. In step 2116, geo-targeting module 15 uses the geo-location data and public information about properties corresponding to that geo-location data to identify matching buyer entries in database 16 for the particular agent. For example, if a property at the geographic location of the mobile agent device 18 is a single-family home with three bedrooms and two bathrooms, geo-targeting module 15 will search the buyer entries for the particular agent to identify any of the agent's buyers interested in a single-family home with three bedrooms and two bathrooms at that geographic location. In step 2118, geo-targeting module 15 sends any matching buyer entries and the public record information to the mobile agent device 18. The mobile agent device 18 will then display the buyer entries and public records information on a display device. In another embodiment, step 2116 is not performed and in step 2118 geo-targeting module 15 sends only the public records information for the one or more properties at the geographic location of the mobile agent device 18 to the mobile agent device 18.

Various embodiments of the invention have been described in fulfillment of the various objects of the invention. It should be understood that these embodiments are illustrative of the principles of the invention. Numerous modifications and adaptations will be apparent to those skilled in the art without departing from the scope of this invention as defined by the attached claims.

What is claimed is:

1. A method comprising:
receiving an identifier of a geographic location from a mobile device;
determining a geographic area that includes the geographic location;
identifying at least one seller entry that includes an identifier of a real estate property located within the geographic area in a database of real estate records for buyers and sellers;
identifying at least one buyer entry in the database that matches the at least one seller entry; and
sending the at least one seller entry and at least one buyer entry to the mobile device.

2. The method of claim 1, wherein the identifier of a geographic location is a position of the mobile device expressed in longitude and latitude coordinates.

3. The method of claim 1, wherein the database of real estate records for buyers and sellers includes information provided by agents.

4. The method of claim 1, further comprising identifying an agent associated with the mobile device and wherein the at least one seller entry or the at least one buyer entry was provided to the database by the agent.

5. The method of claim 1, wherein the geographic area is one of a group consisting of a city, a county, and a neighborhood.

6. The method of claim 1, wherein the database of real estate records for buyers and sellers includes information on properties not listed in the Multiple Listing Service.

7. A method comprising:
receiving an identifier of a geographic location from a mobile device;
determining a geographic area that includes the geographic location;
identifying at least one identifier of a real estate property located within the geographic area in a public database of real estate records for sellers;
identifying at least one buyer entry in a database of real estate records for buyers and sellers that matches the at least one identifier of a real estate property; and
sending the at least one identifier of a real estate property and at least one buyer entry to the mobile device.

8. The method of claim 7, wherein the identifier of a geographic location is a position of the mobile device expressed in longitude and latitude coordinates.

9. The method of claim 7, wherein the public database of real estate records for sellers is a Multiple Listing Service database.

10. The method of claim 7, wherein the database of real estate records for buyers and sellers includes information provided by agents.

11. The method of claim 7, further comprising identifying an agent associated with the mobile device and wherein the at least one buyer entry was provided to the database of real estate records for buyers and sellers by the agent.

12. The method of claim 7, wherein the geographic area is one of a group consisting of a city, a county, and a neighborhood.

13. The method of claim 7, wherein the database of real estate records for buyers and sellers includes information on properties not listed in the Multiple Listing Service.

14. A system comprising:
a database of real estate records for buyers and sellers, each seller entry in the database including an identifier of a real estate property; and
a geo-targeting module configured to receive an identifier of a geographic location from a mobile device, to determine a geographic area that includes the geographic location, to identify at least one seller entry in the database having an identifier of a real estate property located within the geographic area, to identify at least one buyer entry that matches the at least one seller entry, and to provide the at least one seller entry and at least one buyer entry to the mobile device.

15. The system of claim 13, wherein the database of real estate records for buyers and sellers includes information provided by agents.

16. The system of claim 13, wherein the identifier of a geographic location is a position of the mobile device expressed in longitude and latitude coordinates.

17. The system of claim 13, wherein the geographic area is one of a group consisting of a city, a county, and a neighborhood.

18. The system of claim 13, wherein the geo-targeting module is further configured to identify at least one identifier of a real estate property located within the geographic area in a public database of real estate records for sellers, to identify at least one buyer entry in the database of real estate records for buyers and sellers that matches the at least one identifier of a real estate property, and to provide the at least one buyer entry and the at least one identifier of a real estate property to the mobile device.

19. The system of claim 18, wherein the public database of real estate records for sellers is a Multiple Listing Service database.

20. The system of claim 12, wherein the database of real estate records for buyers and sellers includes information on properties not listed in the Multiple Listing Service.
